(19) United States
(12) Patent Application Publication
(10) Pub. No.: US 2026/0043932 A1
(43) Pub. Date: Feb. 12, 2026

(54) UNDERWATER EXPLORATION SYSTEM

(71) Applicant: ADVANCED GEOSCIENCES, INC., Austin, TX (US)

(72) Inventor: Markus Lagmanson, Austin, TX (US)

(21) Appl. No.: 19/197,935

(22) Filed: May 2, 2025

Related U.S. Application Data
(60) Provisional application No. 63/680,052, filed on Aug. 6, 2024.

(51) Int. Cl. G01V 3/165; G05D 1/695; G05D 105/80; G05D 107/00

(52) U.S. Cl. CPC G01V 3/165; G05D 1/695; G05D 2105/87; G05D 2107/27

(57) ABSTRACT

Systems and methods for geophysical exploration of underwater environments are provided. In some embodiments, a geophysical measurement system includes at least one cable having a cable distributed array of electrodes. In some embodiments, the geophysical measurement system further includes at least first and second unmanned vehicles submersible below water for coupling at respective points along the cable so as to maneuver a segment of the cable that includes at least some of the cable distributed array of electrodes through a series of positions and orientations relative to subsurface geologic features below the water, where respective ones of the electrodes along the maneuvered segment participate as transmitters or receivers in electrical resistivity imaging of the subsurface geologic features from at least first and second maneuvered-to positions or orientations that differ from one another.

### CROSS-REFERENCE TO RELATED APPLICATIONS

This application claims the benefit of U.S. Provisional Application No. 63/680,052, filed Aug. 6, 2024, the entirety of which is incorporated by reference herein.

### FIELD OF THE DISCLOSURE

The present disclosure is generally related to a system for underwater exploration and related methods.

### BACKGROUND

Underwater marine surveys are used in a various industries for a variety of applications. Such surveys may be performed using a cable with an array of electrodes towed by a boat, a stationary submerged or floating cable with an array of electrodes, or a cable with an array of electrodes having one end fixed to a shoreline and the other end manually deployed by a boat or by a person (e.g., such as by walking to another side of a body of water). Each of these methods require personnel to pilot the boat and/or to manually move and position the cable within, on top of, or across the body of water. Such methods thus require more labor, more expense, and are time-consuming. Further, manual movement and positioning of the cable can lack positional precision, especially over an extended period of time and/or by fatigued personnel. Additionally, in some cases, the cable may be deployed in areas that are hazardous to humans (e.g., such as an acid solution pond). Thus, existing techniques have not proved entirely satisfactory in all respects.

### SUMMARY

Systems and methods have been provided for geophysical exploration of underwater environments.

In some embodiments in accordance with the present invention(s), a method for measuring an electrical property of an underwater ground surface is provided. In some embodiments, the method includes coupling a first unmanned autonomous vehicle to a first portion of an electrode cable, coupling a second unmanned autonomous vehicle to a second portion of the electrode cable, and simultaneously controlling translational and rotational movements of each of the first and second unmanned autonomous vehicles. In some embodiments, the method further includes while simultaneously controlling the translational and rotational movements, delivering a current to the underwater ground surface through an electrode of the electrode cable configured as a transmitter or measuring an electrical potential associated with the current delivered to the underwater ground surface through the electrode of the electrode cable configured as a receiver.

In some embodiments, the electrode cable includes two or more electrodes disposed between the first and second portions of the electrode cable.

In some embodiments, the electrode is a graphite electrode, a stainless steel electrode, or a conductive ceramic electrode.

In some embodiments, the translational and rotational movements provide up to six degrees of freedom for each of the first and second unmanned autonomous vehicles.

In some embodiments, the translational and rotational movements of each of the first and second unmanned autonomous vehicles are simultaneously controlled to stretch the electrode cable into a substantially straight line between the first and second unmanned autonomous vehicles.

In some embodiments, in a stationary mode of operation, the translational and rotational movements of each of the first and second unmanned autonomous vehicles are simultaneously controlled to maintain the first and second unmanned autonomous vehicles in a substantially stationary position.

In some embodiments, in a moving mode of operation, the translational and rotational movements of each of the first and second unmanned autonomous vehicles are simultaneously controlled to move the first and second unmanned autonomous vehicles through a water column.

In some embodiments, in a hybrid mode of operation, the translational and rotational movements of each of the first and second unmanned autonomous vehicles are simultaneously controlled to maintain one of the first and second unmanned autonomous vehicles in a substantially stationary position while the other of the first and second unmanned autonomous vehicles moves through a water column.

In some embodiments, the translational and rotational movements of each of the first and second unmanned autonomous vehicles are simultaneously controlled to move the first and second unmanned autonomous vehicles along an axis coplanar with the substantially straight line of the electrode cable.

In some embodiments, the translational and rotational movements of each of the first and second unmanned autonomous vehicles are simultaneously controlled to move the first and second unmanned autonomous vehicles along an axis perpendicular to the substantially straight line of the electrode cable.

In some embodiments, the translational and rotational movements of each of the first and second unmanned autonomous vehicles are simultaneously controlled to maintain the first unmanned autonomous vehicle in a substantially stationary position while the second unmanned autonomous vehicle moves in a circular pattern through a water column and around the first unmanned autonomous vehicle.

In some embodiments, the translational and rotational movements of each of the first and second unmanned autonomous vehicles are simultaneously controlled to maintain the first unmanned autonomous vehicle in a substantially stationary position while the second unmanned autonomous vehicle moves in a spherical shell pattern through a water column and around the first unmanned autonomous vehicle.

In some embodiments, the translational and rotational movements of each of the first and second unmanned autonomous vehicles are simultaneously controlled to move the first and second unmanned autonomous vehicles in an orthogonal grid pattern through a water column.

In some embodiments, the orthogonal grid pattern includes a pattern defined along X, Y, or Z axes and their respective planes.

In some embodiments, the translational and rotational movements of each of the first and second unmanned autonomous vehicles are simultaneously controlled to move the first and second unmanned autonomous vehicles along a water surface, the water surface defining a plane.

In some embodiments, the translational and rotational movements of each of the first and second unmanned autonomous vehicles are simultaneously controlled to move the first and second unmanned autonomous vehicles to position the electrode cable on or near the underwater ground surface.

In some embodiments in accordance with the present invention(s), a geophysical measurement system including at least one cable having a cable distributed array of electrodes is provided. In some embodiments, the geophysical measurement system further includes at least first and second unmanned vehicles submersible below water for coupling at respective points along the cable so as to maneuver a segment of the cable that includes at least some of the cable distributed array of electrodes through a series of positions and orientations relative to subsurface geologic features below the water, where respective ones of the electrodes along the maneuvered segment participate as transmitters or receivers in electrical resistivity imaging of the subsurface geologic features from at least first and second maneuvered-to positions or orientations that differ from one another.

In some embodiments, the first and second unmanned vehicles are operable to tension the maneuvered segment of the cable and thereby maintain therebetween a substantially linear portion of the cable distributed array of electrodes.

In some embodiments, the first, the second, and further maneuvered-to positions or orientations provide one or more of: axial movement of the tensioned and maneuvered segment of the cable, movement of the tensioned and maneuvered segment of the cable generally orthogonally to an axis of the tensioned and maneuvered segment of the cable, movement of one end of the tensioned and maneuvered segment of the cable while maintaining the other end at a substantially fixed position to define a fan pattern of maneuvered-to positions and orientations, and movement of one end of the tensioned and maneuvered segment of the cable while maintaining the other end at a substantially fixed position to define a generally spherical pattern of maneuvered-to positions and orientations.

In some embodiments, the geophysical measurement system further includes communication media disposed within the cable, where maneuvering of the first and second unmanned vehicles is coordinated, at least in part, via instructions or control signals conveyed over the cable disposed communication media.

In some embodiments, the geophysical measurement system further includes a transmitter current source disposed on a surface vessel, where the cable defines a transmitter current path from the surface vessel to at least one of cable distributed array of electrodes along the maneuvered segment of the cable between the first and second unmanned vehicles.

In some embodiments, either or both of the first and second unmanned vehicles are remotely operable submersibles.

In some embodiments, either or both of the first and second unmanned vehicles are autonomous underwater vehicles maneuverable according to a programmed survey plan.

In some embodiments, either or both of the first and second unmanned vehicles are at least semi-autonomously maneuverable relative to underwater features or objects according to on-vehicle sensor information or telemetry.

In some embodiments, the programmed survey plan is modifiable based on electrical resistivity imaging data collected by the geophysical measurement system.

These and other embodiments in accordance with the present invention(s) will be understood with reference to the description and appended claims which follow.

### BRIEF DESCRIPTION OF THE DRAWINGS

The present invention(s) are illustrated by way of examples and not limitation with reference to the accompanying figures, in which like references generally indicate similar elements or features.

FIG. 1 illustrates an exemplary underwater exploration system, in accordance with at least some embodiments.

FIG. 2 illustrates another exemplary underwater exploration system, in accordance with at least some embodiments.

FIG. 3 illustrates the six degrees of freedom in which an unmanned autonomous vehicle may move, in accordance with some embodiments.

FIG. 4 provides an example of axial movement of unmanned autonomous vehicles having an electrode cable coupled therebetween, in accordance with some embodiments.

FIG. 5 provides an example of perpendicular movement of unmanned autonomous vehicles having an electrode cable coupled therebetween, in accordance with some embodiments.

FIG. 6 provides another example of perpendicular movement of unmanned autonomous vehicles having an electrode cable coupled therebetween, in accordance with some embodiments.

FIG. 7 provides an example of fan pattern movement of unmanned autonomous vehicles having an electrode cable coupled therebetween, in accordance with some embodiments.

FIG. 8 provides an example of spherical pattern movement of unmanned autonomous vehicles having an electrode cable coupled therebetween, in accordance with some embodiments.

FIG. 9 provides an example of surface plane movement of unmanned autonomous vehicles having an electrode cable coupled therebetween, in accordance with some embodiments.

FIG. 10 provides an example of sub-bottom placement of an electrode cable using unmanned autonomous vehicles, in accordance with some embodiments.

Skilled artisans will appreciate that elements or features in the figures are illustrated for simplicity and clarity and have not necessarily been drawn to scale. For example, the dimensions or prominence of some of the illustrated elements or features may be exaggerated relative to other elements or features in an effort to help to improve understanding of embodiments of the present invention.

### DETAILED DESCRIPTION

Embodiments of the present disclosure provide an underwater exploration system designed for efficient and accurate investigation of subaqueous environments. While not limited thereto, some exemplary applications of the disclosed underwater exploration system include detection and analysis of gas hydrates, locating geoliner leaks in reserve pits (e.g., in the petroleum industry) and tailing ponds (e.g., in the mining industry), and providing subsurface information to support site selection and foundation design (e.g., such as determining that a particular subsurface has appropriate physical properties for an offshore windmill foundation, oil platform foundation, or other such foundations, to be installed), cable route planning, environmental impact assessments, construction safety, and long-term stability monitoring. In some embodiments, the disclosed system employs at least a pair of unmanned autonomous vehicles (e.g., such as autonomous underwater/on-water vehicles (AUVs) or remotely operated vehicles (ROVs)), in conjunction with an electrode cable to facilitate various measurement and exploration activities.

The electrode cable, in various embodiments, includes an array of electrodes distributed along the electrode cable. Thus, the electrode cable may be equivalently referred to as an electrode array, an electrode cable array, or a cable distributed array. By way of example, each electrode of the electrode array may be configured as a transmitter (transmitter electrodes) or as a receiver (receiver electrodes). Thus, in some cases, the electrodes may also be referred to as sensors, and the electrode cable may also be referred to as a sensor cable. Employing an electrode array, the underwater exploration system disclosed herein may use electrical resistivity imaging (ERI), also referred to as DC resistivity (DCR), to map subsurface properties by measuring an electrical resistivity of materials in a subsurface (e.g., such an underwater subsurface). In some embodiments, the disclosed underwater exploration system may also use induced polarization (IP) imaging to map the subsurface properties. An ERI scan can be performed, using appropriate ERI equipment, to inject an electrical current into a medium (e.g., such as a body of water) through transmitter electrodes on the electrode cable while measuring a voltage potential between two or more other receiver electrodes. Data collected from the ERI scan can be used to generate 2D and/or 3D images of the mapped subsurface, and further provide information regarding the resistivity of materials disposed within the subsurface. In some examples, the ERI scan can further be used to generate 4D images of the mapped subsurface, the 4D images including time-lapses of the 2D and/or 3D image data. In various embodiments, the transmitter electrodes and receiver electrodes may be on the same electrode cable or on different electrode cables. While the electrode cable is described as including an array of electrodes, more generally the electrode cable may include two or more electrodes. In accordance with some embodiments, the electrode cable may include a multi-conductor cable. The electrode cable may be a passive cable having no dedicated communication functionality. In other examples, the electrode cable may include twisted-pair cables for Gigabit Ethernet communications, for power, for transmitting, as well as for other applications. If the electrode cable provides for Gb Ethernet communications, the electrode cable may be used for communication between unmanned autonomous vehicles, which are coupled to the electrode cable and are configured to move the electrode cable.

In various embodiments, the electrodes on the electrode cable may be fabricated from materials such as graphite, stainless steel, conductive ceramics, or other suitable conductive materials. Thus, the electrodes on the electrode cable may also be generally described as being composed of a conductive material or a conductive electrode material. Further, in some examples, the electrodes on the electrode cable are made of a non-corrosive material and are not subject to electrochemical degradation. In some examples, the electrodes make a galvanic connection between the ERI scanning equipment and the surrounding medium. While the embodiments disclosed herein are generally directed to underwater exploration, the surrounding medium can more generally include a body of water, earth, mud, or other geological features where an electric current can be passed therethrough.

In accordance with embodiments of the present disclosure, an electrode cable (or multiple electrode cables) may be maneuvered by an AUV or ROV, as noted above. More generally, the electrode cable may be maneuvered by a robot or other unmanned autonomous vehicle such as an unmanned underwater vehicle (UUV) or an unmanned aerial vehicle (UAV), in some cases. An unmanned underwater vehicle (UUV) may include, in some embodiments, the AUV or ROV. In some examples, an unmanned underwater vehicle may be referred to as an underwater drone. An unmanned aerial vehicle (UAV) may include a drone, in some cases. By way of example, the term “drone” may be used to describe an autonomous vehicle that either swims under or on a water surface, drives on land or flies in the air using a “fixed wing” aircraft, single (helicopter) or multi (two or more) rotor aircraft. Fixed wing aircraft look and feel like airplanes while the multi-rotor aircraft may have several rotors (propellers).

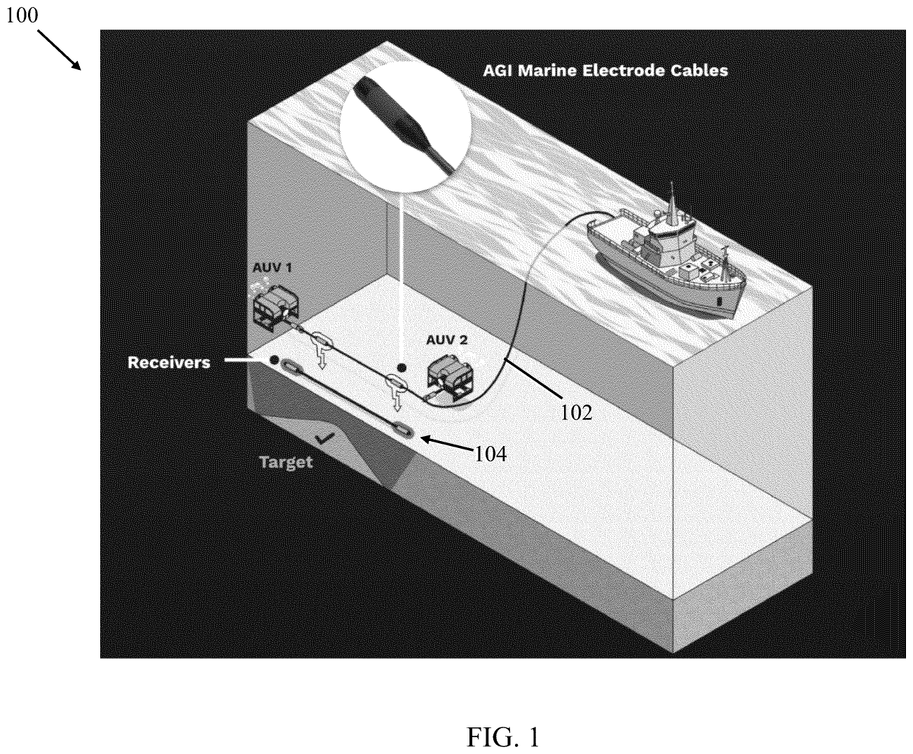

Referring to FIG. 1, illustrated therein is an exemplary underwater exploration system 100, in accordance with at least some embodiments. As shown, the system 100 includes a first unmanned underwater vehicle (“AUV 1”) and a second unmanned underwater vehicle (“AUV 2”) positioned at, and coupled to, opposite ends (or positioned at, and coupled to, respective first and second portions) of an electrode cable 102 and which are configured to move the electrode cable 102 (e.g., within a body of water). While not limited to such an implementation, in the illustrated example, the electrode cable 102 may be further coupled to instrumentation (e.g., used to drive the electrode cable 102) housed on a surface ship. In some other examples, the instrumentation may alternatively be placed in a pressure housing (e.g., mounted onto an ROV) and positioned on an underwater surface, coupled to one of the unmanned underwater vehicles, or coupled to a separate unmanned underwater vehicle. When the instrumentation is placed away from the ship, a communications link (e.g., such as a fiber optic link) may be provided between the instrumentation and the ship. In the exemplary system 100, electrodes in the electrode cable 102 are configured as transmitter electrodes while another electrode cable 104, placed along an underwater surface, includes electrodes configured as receiver electrodes. A subsurface mapping target region (e.g., such as a region including gas hydrates) may be disposed in a sub-bottom surface beneath the electrode cable 104, and an ERI scan of the target region may be performed using the electrode cables 102, 104.

In an alternative implementation, electrodes in the electrode cable 102 may be configured as receiver electrodes while electrodes in the electrode cable 104 may be configured as transmitter electrodes. In another example, rather than having a single electrode cable 102 moved (controlled) by the single pair of unmanned underwater vehicles (AUV 1/AUV 2), multiple electrode cables (having electrodes configured as transmitter electrodes, receiver electrodes, or a combination thereof) may be moved (controlled) by respective pairs of unmanned underwater vehicles. Further, in some cases, rather than having a single electrode cable 104 placed along the underwater surface, multiple electrode cables (having electrodes configured as transmitter electrodes, receiver electrodes, or a combination thereof) may be placed along the underwater surface.

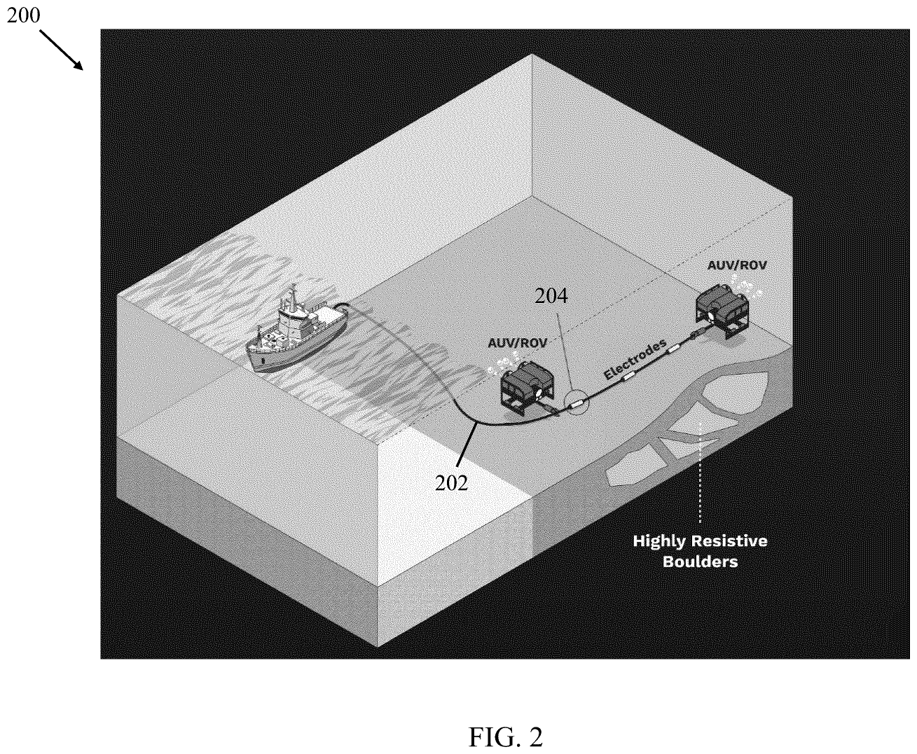

Referring to FIG. 2, illustrated therein is an exemplary underwater exploration system 200, in accordance with some embodiments. The system 200, like the system 100 discussed above, includes a first and second unmanned underwater vehicles (“AUV/ROV”) that are positioned at, and coupled to, opposite ends (or positioned at, and coupled to, respective first and second portions) of an electrode cable 202 and which are configured to move the electrode cable 202 (e.g., within a body of water). While not limited to such an implementation, in the illustrated example, the electrode cable 202 may also be further coupled to instrumentation (e.g., used to drive the electrode cable 202) housed on a surface ship. However, as noted above, the instrumentation may alternatively be placed in a pressure housing (e.g., mounted onto an ROV) and positioned on an underwater surface, coupled to one of the unmanned underwater vehicles, or coupled to a separate unmanned underwater vehicle. Once again, when the instrumentation is placed away from the ship, a communications link (e.g., such as a fiber optic link) may be provided between the instrumentation and the ship. In the exemplary system 200, different ones of electrodes 204 in the electrode cable 202 may be configured as transmitter electrodes and receiver electrodes, respectively. A subsurface mapping target region (e.g., such as a region including highly resistive boulders) may be disposed in the sub-bottom surface beneath the electrode cable 202, and an ERI scan of the target region may be performed using the electrode cable 202. In an alternative implementation, rather than having a single electrode cable 202 moved (controlled) by the single pair of unmanned underwater vehicles (AUV/ROV), multiple electrode cables (having electrodes configured, respectively, as transmitter electrodes and receiver electrodes) may be moved (controlled) by respective pairs of unmanned underwater vehicles.

As described above with reference to the exemplary systems 100, 200, a pair of unmanned underwater vehicles (or more generally a pair of unmanned autonomous vehicles) may be positioned at, and coupled to, opposite ends (or positioned at, and coupled to, respective first and second portions) of an electrode cable, the pair of unmanned underwater vehicles configured to move the electrode cable (e.g., within a body of water). However, in some examples, more than two unmanned underwater vehicles may likewise be used in connection with a single electrode cable. For instance, in some embodiments, a third unmanned underwater vehicle may be positioned at, and coupled to, a middle portion of the electrode cable (e.g., generally spaced equidistant from the first and second unmanned underwater vehicles disposed at ends of the electrode cable), the third unmanned underwater vehicle also configured to move the electrode cable and further configured to help maintain the electrode cable in a substantially straight line between the first and second unmanned underwater vehicles to ensure precise measurement and data collection.

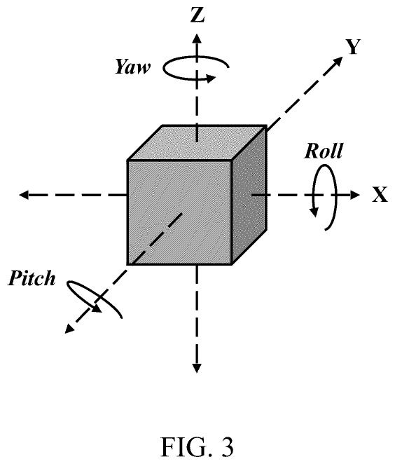

In some embodiments, each of the two (or more) unmanned autonomous vehicles, used to control movement of an electrode cable, has up to six degrees of freedom, which include translational movements along an X-axis, a Y-axis, and a Z-axis and rotational movements around the X-axis (roll), the Y-axis (pitch), and the Z-axis (yaw), as illustrated in FIG. 3. By simultaneously controlling the translational and rotational movements of the unmanned autonomous vehicles coupled to the electrode cable, embodiments of the present disclosure provide for the electrode cable to be maneuvered in up to six degrees of freedom at each end of the electrode cable to which respective ones of the unmanned autonomous vehicles are coupled (or at each of the first and second portions of the electrode cable to which respective ones of the unmanned autonomous vehicles are coupled). Further, when a third unmanned autonomous vehicle is coupled to another (middle) portion of the electrode cable, the electrode cable may also be maneuvered in up to six degrees of freedom at the middle portion of the electrode cable to which the third unmanned autonomous vehicle is coupled.

In accordance with various embodiments, the two (or more) unmanned autonomous vehicles may be operated in a variety of ways. Generally, and by way of example, the unmanned autonomous vehicles described herein are untethered and may be pre-programmed before deployment to navigate a particular flight path. In some embodiments, data that is collected along the particular flight path may be used to modify the pre-programmed flight path, for example, to navigate the unmanned autonomous vehicles (and the electrode cable coupled therebetween) along a modified flight path that is more likely to have subsurface geologic features of interest (e.g., as determined by the data collected along the particular flight path). In at least some cases, the unmanned vehicles may include tethered vehicles (e.g., such as an ROV) that may be operated in real-time by an operator (e.g., on a surface ship or onshore). In some embodiments, prior to performing an ERI scan, side scan sonar and/or bathymetry data may be collected in order to provide topographic data of an underwater surface (e.g., such as a seafloor). Having the topographic data, in some embodiments, the unmanned autonomous vehicles may be pre-programmed to navigate the contours of the ocean or underwater surface, without running into debris or other obstructions on the seafloor.

In some examples, the two (or more) unmanned vehicles may be configured to wirelessly communicate with each other, or in some cases with a surface ship, using radio frequency (RF)-based underwater wireless communication, acoustic-based underwater wireless communication, optical-based underwater wireless communication, or magnetic induction (MI)-based underwater wireless communication. Also, as described above, if the electrode cable provides for Gb Ethernet communications, the electrode cable may be used for communication between respective unmanned vehicles. In some embodiments, and by leveraging the communications between the unmanned vehicles (whether autonomous or operated by a remote operator), one unmanned vehicle may be used to control one (or more) other unmanned vehicles. As one example, two (or more) unmanned autonomous vehicles may be configured in a master-slave configuration, where one unmanned vehicle is assigned the role of the master while the remaining one (or more) unmanned vehicles act as slaves. The master unmanned vehicle is thus configured (programmed) to control the actions (movements) of the slave unmanned vehicle. The master unmanned vehicle may communicate instructions to the slave unmanned vehicle, via one or more of the communication methods described above, which executes the instructions accordingly. In another example, two unmanned vehicles may be configured in a leader-follower configuration, where one unmanned vehicle is assigned the role of leader and includes a tethered vehicle (e.g., such as an ROV) that is operated by a remote operator, while the other unmanned vehicle is assigned the role of follower and includes an autonomous unmanned vehicle (AUV). In this case, the follower unmanned vehicle acts as an autonomous follower that follows the movements of the leader unmanned vehicle based on the instructions received from the remote operator and based on communications between the leader and follower unmanned vehicles.

Generally, and in various embodiments, the translational and rotational movements of each of the first and second unmanned autonomous vehicles coupled to the electrode cable are simultaneously controlled to stretch the electrode cable into a substantially straight line between the first and second unmanned autonomous vehicles to ensure precise measurement and data collection. To be sure, in some cases, the electrode cable may define a substantially straight, curvilinear, or curved line between the first and second unmanned autonomous vehicles. In some examples, tensile strength meters (or tensile testers) may be coupled along the electrode cable (where the electrode cable is anchored to the unmanned autonomous vehicles) in order to measure the force with which the unmanned autonomous vehicles are pulling on the electrode cable. As a result, a force range may be defined to ensure that the electrode cable is stretched taut (e.g., stretched into a substantially straight line) between the first and second unmanned autonomous vehicles. In some embodiments, such tensile strength meters may include a three-axis strain gauge, or other suitable strain gauge.

In accordance with the disclosed embodiments, the underwater exploration system may thus be described as including at least two unmanned autonomous vehicles that move about in 3D space through a water column while keeping the electrode cable stretched in a substantially straight line between the at least two unmanned autonomous vehicles. In addition to the variety of movement capabilities described in more detail below, the unmanned autonomous vehicles coupled to the electrode cable may be used to move the electrode cable along the contours of the ocean or underwater surface (as noted above), to move the electrode cable along a plane having a substantially even elevation, to keep the electrode cable in a substantially stationary position, or to drape the electrode cable down onto an underwater surface (e.g., an ocean surface). Further, in various embodiments, ERI scans may be performed while the unmanned autonomous vehicles, and thus the electrode cable, are moving. In other examples, an ERI scan may be performed while the unmanned autonomous vehicles, and thus the electrode cable, are in a substantially stationary position. In still another example, the unmanned autonomous vehicles may be moved to a desired location/position prior to scanning. Once reaching the desired location/position, in some examples, a first ERI scan may be performed while the electrode cable is in a substantially stationary position. Thereafter, the electrode cable may be moved using one or both of the unmanned autonomous vehicles into another location/position, and a second ERI scan may be performed after the electrode cable is moved and while the electrode cable remains in a substantially stationary position. Such a process may be repeated as many times as needed to map subsurface properties. Thus, embodiments of the present disclosure provide for collection of one or more ERI scans without the use of costly (and prone to error) human labor.

Elaborating on the operational modes of the disclosed system, the operational modes may include: (i) a stationary mode, where both ends of the electrode cable (and thus both of the unmanned autonomous vehicles) remain stationary in the water column; (ii) a hybrid mode, where one end of the electrode cable (and thus one of the unmanned autonomous vehicles) remains stationary while the other end of the electrode cable (and thus the other one of the unmanned autonomous vehicles) moves through the water column; and (iii) a moving mode, where both ends of the electrode cable (and thus both of the unmanned autonomous vehicles) move simultaneously through the water column. In each of the above scenarios, the two (or more) unmanned autonomous vehicles can be described as having their translational and rotational movements simultaneously controlled to provide the desired movements of the electrode cable.

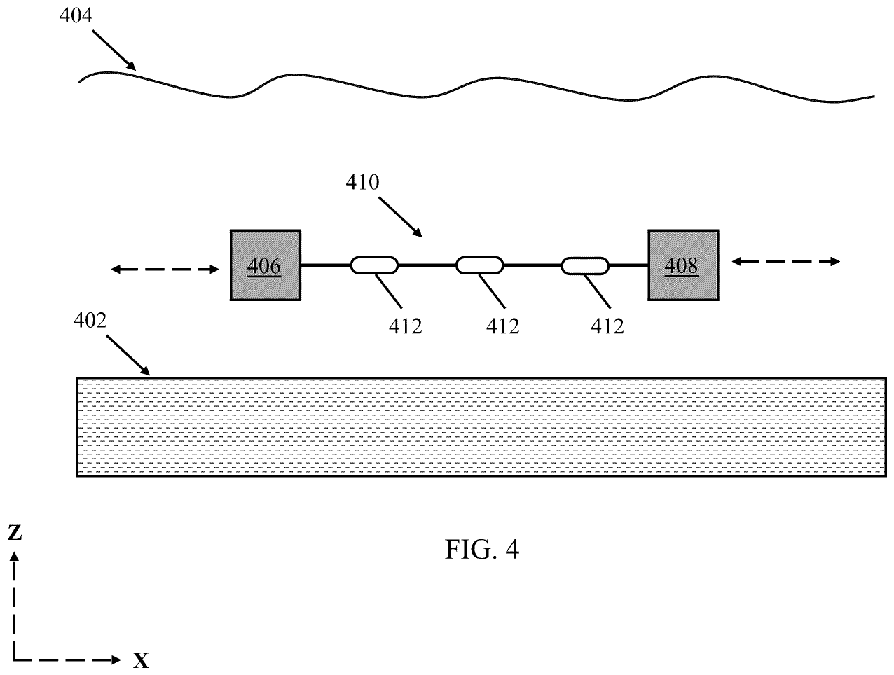

Elaborating on additional movement capabilities of the disclosed system, the movement capabilities may further include simultaneously controlling the translational and rotational movements of the two (or more) unmanned autonomous vehicles to provide any of a plurality of movements. By way of illustration, FIGS. 4-10 provide some examples of movement, with respect to an underwater surface 402 (or ocean surface 402) and a water surface 404, of a first unmanned autonomous vehicle 406, a second unmanned autonomous vehicle 408, and an electrode cable 410 coupled therebetween, the electrode cable 410 having a plurality of electrodes 412 configured as transmitter electrodes or receiver electrodes. For clarity of discussion, instrumentation used to drive the electrode cable 410 is not shown. Additionally, unless otherwise stated and in various embodiments, the electrode cable 410 may be stretched into a substantially straight line between the first and second unmanned autonomous vehicles 406, 408 while moving in accordance with any of the movement capabilities and/or operational modes described herein.

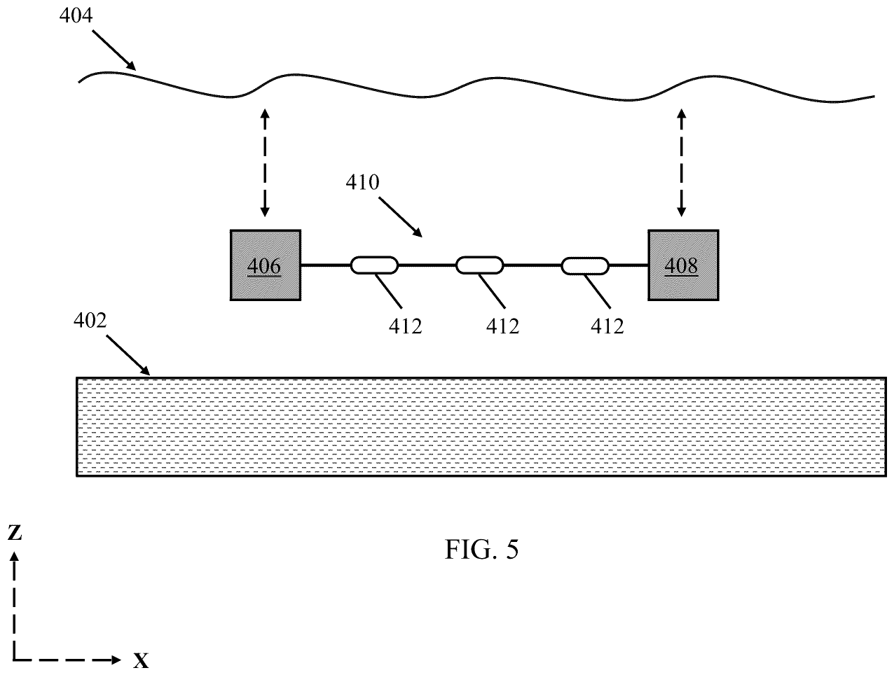

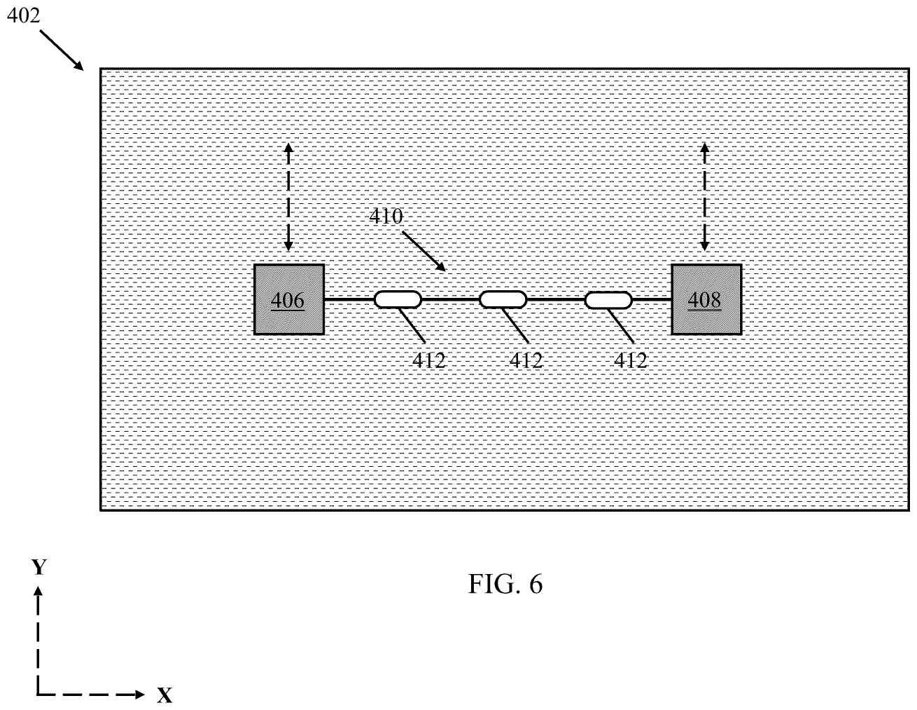

FIG. 4 provides an example of axial movement, where the first and second unmanned autonomous vehicles 406, 408 move simultaneously along an axis (X-axis, in this case) defined by the substantially straight electrode cable 410 stretched between the first and second unmanned autonomous vehicles 406, 408. FIG. 5 provides an example of perpendicular movement, where the first and second unmanned autonomous vehicles 406, 408 move along an axis (Z-axis, in this example) that is perpendicular to the axis (X-axis, in this case) defined by the substantially straight electrode cable 410 stretched between the first and second unmanned autonomous vehicles 406, 408. FIG. 6 provides another example of perpendicular movement, where the first and second unmanned autonomous vehicles 406, 408 move along an axis (Y-axis, in this example) that is perpendicular to the axis (X-axis, in this case) defined by the substantially straight electrode cable 410 stretched between the first and second unmanned autonomous vehicles 406, 408. In some cases, by combining the axial and perpendicular movements illustrated in FIGS. 4-6, the first and second unmanned autonomous vehicles 406, 408 may be configured to move in an orthogonal grid pattern through the water column, where movement is allowed along X, Y, or Z axes and their respective planes.

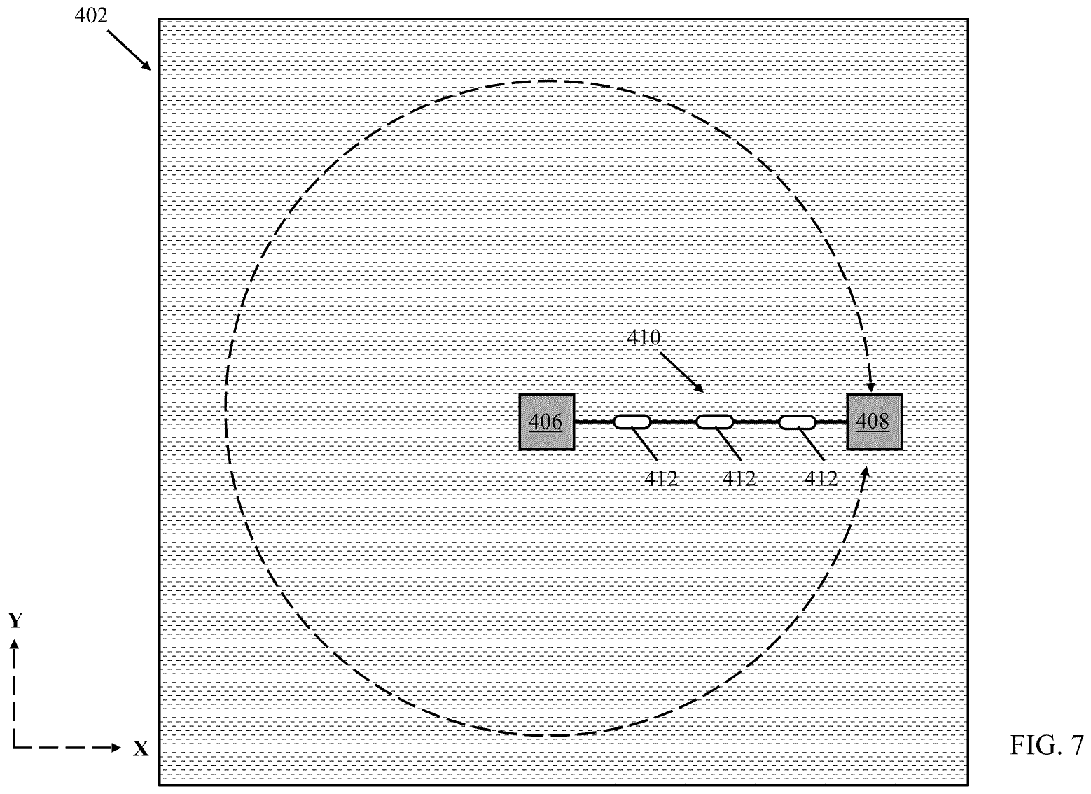

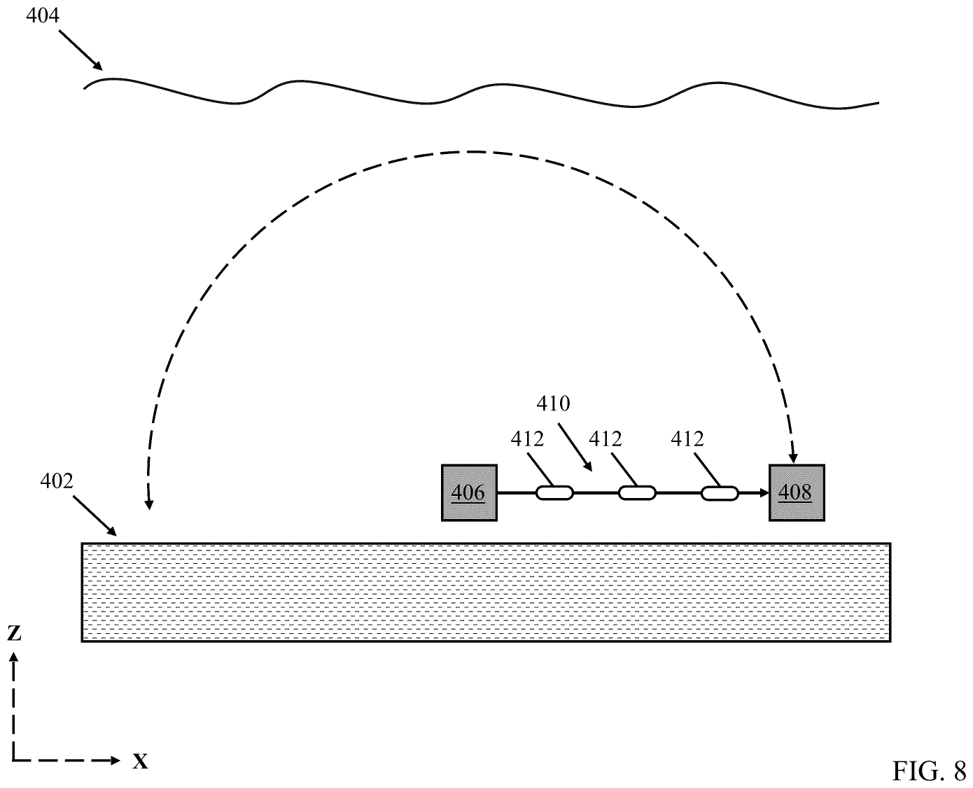

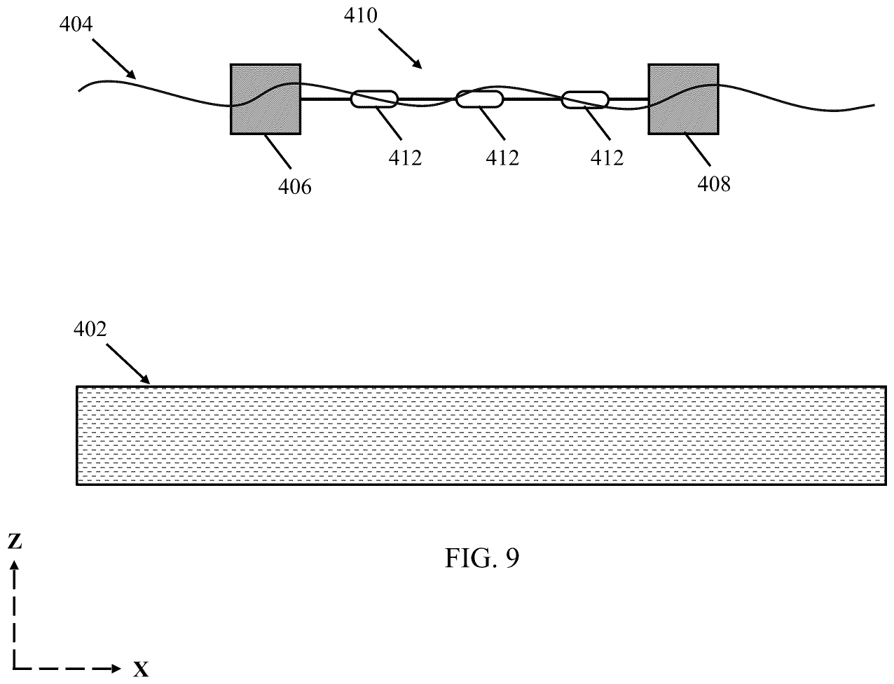

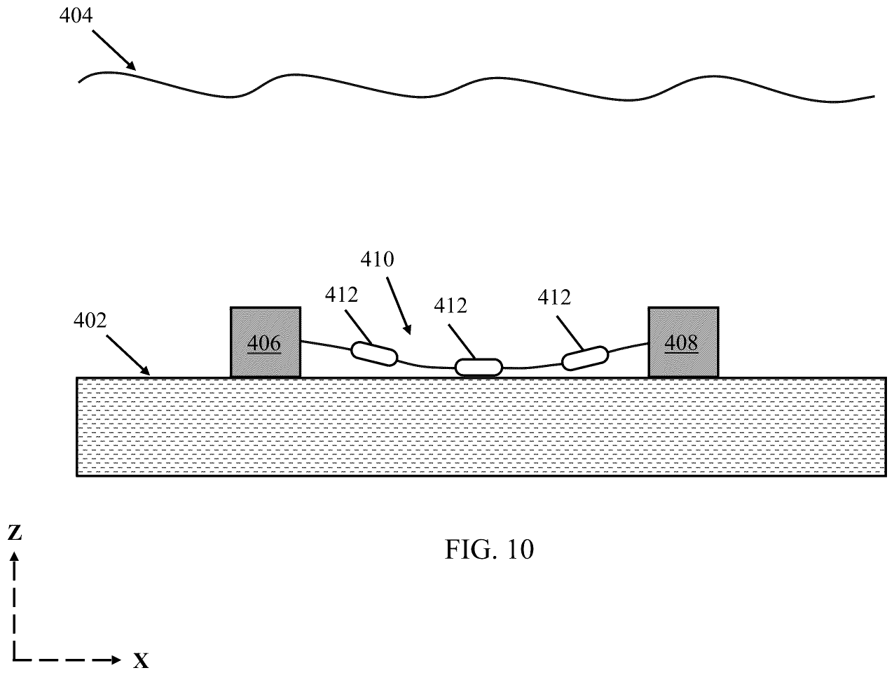

FIG. 7 provides an example of fan pattern movement, where the first unmanned autonomous vehicle 406 remains substantially stationary while the second unmanned autonomous vehicle 408 moves in a circular pattern around the first unmanned autonomous vehicle 406. FIG. 8 provides an example of spherical pattern movement, where the first unmanned autonomous vehicle 406 remains substantially stationary while the second unmanned autonomous vehicle 408 moves in a spherical shell pattern around the first unmanned autonomous vehicle 406. FIG. 9 provides an example of surface plane movement, where the first and second unmanned autonomous vehicles 406, 408 move along the water surface 404, the water surface 404 defining a plane. In some embodiments, the example of FIG. 9 may be exemplary of a shallow water (e.g., pond) application, where the first and second unmanned autonomous vehicles 406, 408 are time-synced with GPS due to the availability of a GPS signal at or near the water surface 404. FIG. 10 provides an example of sub-bottom placement, where the first and second unmanned autonomous vehicles 406, 408 are maneuvered to place the electrode cable 410 on the underwater surface 402, which may be somewhat flat or have some varying topography over which the electrode cable 410 is draped.

Embodiments of the present disclosure thus allow for versatile and precise exploration of underwater environments and are particularly suited for the detection and analysis of gas hydrates. The flexibility in movement and electrode placement ensures comprehensive coverage and detailed data collection, making it an invaluable tool for underwater research and exploration. In addition, the described system harnesses the advanced maneuverability of unmanned underwater vehicles (e.g., such as AUVs/ROVs) in combination with a specially designed electrode cable to provide an effective solution for underwater exploration. Moreover, the disclosed capabilities in various movement patterns and electrode configurations present significant advancements in the field of marine geophysical exploration.

In at least some prior implementations, the electrode cable would be deployed to multiple locations by humans. In some cases, the area of deployment is hazardous to humans. Using machines (drones or other unmanned autonomous vehicles) to position the electrode cable is cost-effective as no labor is required of humans to move the electrode cable. Labor is also paid while on-site, even if movement of the electrode cable is not needed. In the case of hazardous locations (e.g., such as acid solution ponds), removing the human element would be safer and less costly as humans require hazard pay. In contrast, the present embodiments disclose a machine (e.g., such as a drone or other unmanned autonomous vehicle) that does not fatigue, does not need a wage or health insurance, and which can enter dangerous environments or even survive in environments not fit for humans (e.g., such as underwater or in radiological sites). Moreover, machines can also maintain high positional precision for long periods of time. Embodiments of the present disclosure thus provide for lowered data acquisition cost, increased data collection speed, an increase in data points collected, and increased resolution of the data.

The foregoing outlines features of several embodiments so that those skilled in the art may better understand the aspects of the present disclosure. Those skilled in the art should appreciate that they may readily use the present disclosure as a basis for designing or modifying other systems or methods for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

For example, in some alternative embodiments, a drone (or other unmanned autonomous vehicle) may be used to deploy an electrode cable (for ERI scans) away from a shoreline of a body of water, and to keep the electrode cable in a static location/position for a period of time. In an example, a first end of the electrode cable may be held or affixed at the shoreline while a second end of the electrode cable is coupled to the drone (or other unmanned autonomous vehicle) to move the electrode cable to a desired target location in the body of water.

In at least some prior implementations, after affixing the first end of the electrode cable to the shoreline, a person could deploy the electrode cable by using a boat, which would require an additional person to pilot the boat and add additional expense. Alternatively, a person can walk to the other side of the body of water, if there is a shore nearby, and stretch the electrode cable across the body of water. Walking or moving takes time, and communications between people on different sides of the body of water becomes less effective at greater distances. In contrast, in the present alternative embodiments and aided by GPS technology, a drone (or other unmanned autonomous vehicle), rather than a person in a boat or a person walking along the shoreline, can vector its motors to stay put after deploying (pulling) the electrode cable away from the shore. Thus, the present alternative embodiments would only need one person to deploy an electrode cable from a shore of a body of water. Additionally, the time to deploy the electrode cable in the field will be reduced which will lead to less expensive deployments, more accurate data, and more data collected.

What is claimed is:

1. A method for measuring an electrical property of an underwater ground surface, comprising:
coupling a first unmanned autonomous vehicle to a first portion of an electrode cable;
coupling a second unmanned autonomous vehicle to a second portion of the electrode cable;
simultaneously controlling translational and rotational movements of each of the first and second unmanned autonomous vehicles; and
while simultaneously controlling the translational and rotational movements, delivering a current to the underwater ground surface through an electrode of the electrode cable configured as a transmitter or measuring an electrical potential associated with the current delivered to the underwater ground surface through the electrode of the electrode cable configured as a receiver.

2. The method of claim 1, wherein the electrode cable includes two or more electrodes disposed between the first and second portions of the electrode cable.

3. The method of claim 1, wherein the electrode is a graphite electrode, a stainless steel electrode, or a conductive ceramic electrode.

4. The method of claim 1, wherein the translational and rotational movements provide up to six degrees of freedom for each of the first and second unmanned autonomous vehicles.

5. The method of claim 1, wherein the translational and rotational movements of each of the first and second unmanned autonomous vehicles are simultaneously controlled to stretch the electrode cable into a substantially straight line between the first and second unmanned autonomous vehicles.

6. The method of claim 1, wherein in a stationary mode of operation, the translational and rotational movements of each of the first and second unmanned autonomous vehicles are simultaneously controlled to maintain the first and second unmanned autonomous vehicles in a substantially stationary position.

7. The method of claim 1, wherein in a moving mode of operation, the translational and rotational movements of each of the first and second unmanned autonomous vehicles are simultaneously controlled to move the first and second unmanned autonomous vehicles through a water column.

8. The method of claim 1, wherein in a hybrid mode of operation, the translational and rotational movements of each of the first and second unmanned autonomous vehicles are simultaneously controlled to maintain one of the first and second unmanned autonomous vehicles in a substantially stationary position while the other of the first and second unmanned autonomous vehicles moves through a water column.

9. The method of claim 5, wherein the translational and rotational movements of each of the first and second unmanned autonomous vehicles are simultaneously controlled to move the first and second unmanned autonomous vehicles along an axis coplanar with the substantially straight line of the electrode cable.

10. The method of claim 5, wherein the translational and rotational movements of each of the first and second unmanned autonomous vehicles are simultaneously controlled to move the first and second unmanned autonomous vehicles along an axis perpendicular to the substantially straight line of the electrode cable.

11. The method of claim 1, wherein the translational and rotational movements of each of the first and second unmanned autonomous vehicles are simultaneously controlled to maintain the first unmanned autonomous vehicle in a substantially stationary position while the second unmanned autonomous vehicle moves in a circular pattern through a water column and around the first unmanned autonomous vehicle.

12. The method of claim 1, wherein the translational and rotational movements of each of the first and second unmanned autonomous vehicles are simultaneously controlled to maintain the first unmanned autonomous vehicle in a substantially stationary position while the second unmanned autonomous vehicle moves in a spherical shell pattern through a water column and around the first unmanned autonomous vehicle.

13. The method of claim 1, wherein the translational and rotational movements of each of the first and second unmanned autonomous vehicles are simultaneously controlled to move the first and second unmanned autonomous vehicles in an orthogonal grid pattern through a water column.

14. The method of claim 13, wherein the orthogonal grid pattern includes a pattern defined along X, Y, or Z axes and their respective planes.

15. The method of claim 1, wherein the translational and rotational movements of each of the first and second unmanned autonomous vehicles are simultaneously controlled to move the first and second unmanned autonomous vehicles along a water surface, the water surface defining a plane.

16. The method of claim 1, wherein the translational and rotational movements of each of the first and second unmanned autonomous vehicles are simultaneously controlled to move the first and second unmanned autonomous vehicles to position the electrode cable on or near the underwater ground surface.

17. A geophysical measurement system comprising:
at least one cable including a cable distributed array of electrodes;
at least first and second unmanned vehicles submersible below water for coupling at respective points along the cable so as to maneuver a segment of the cable that includes at least some of the cable distributed array of electrodes through a series of positions and orientations relative to subsurface geologic features below the water, wherein respective ones of the electrodes along the maneuvered segment participate as transmitters or receivers in electrical resistivity imaging of the subsurface geologic features from at least first and second maneuvered-to positions or orientations that differ from one another.

18. The geophysical measurement system of claim 17, wherein the first and second unmanned vehicles are operable to tension the maneuvered segment of the cable and thereby maintain therebetween a substantially linear portion of the cable distributed array of electrodes.

19. The geophysical measurement system of claim 18, wherein the first, the second, and further maneuvered-to positions or orientations provide one or more of:
axial movement of the tensioned and maneuvered segment of the cable;
movement of the tensioned and maneuvered segment of the cable generally orthogonally to an axis of the tensioned and maneuvered segment of the cable;
movement of one end of the tensioned and maneuvered segment of the cable while maintaining the other end at a substantially fixed position to define a fan pattern of maneuvered-to positions and orientations; and
movement of one end of the tensioned and maneuvered segment of the cable while maintaining the other end at a substantially fixed position to define a generally spherical pattern of maneuvered-to positions and orientations.

20. The geophysical measurement system of claim 17, further comprising:
communication media disposed within the cable,
wherein maneuvering of the first and second unmanned vehicles is coordinated, at least in part, via instructions or control signals conveyed over the cable disposed communication media.

21. The geophysical measurement system of claim 17, further comprising:
a transmitter current source disposed on a surface vessel, wherein the cable defines a transmitter current path from the surface vessel to at least one of cable distributed array of electrodes along the maneuvered segment of the cable between the first and second unmanned vehicles.

22. The geophysical measurement system of claim 17, wherein either or both of the first and second unmanned vehicles are remotely operable submersibles.

23. The geophysical measurement system of claim 17, wherein either or both of the first and second unmanned vehicles are autonomous underwater vehicles maneuverable according to a programmed survey plan.

24. The geophysical measurement system of claim 17, wherein either or both of the first and second unmanned vehicles are at least semi-autonomously maneuverable relative to underwater features or objects according to on-vehicle sensor information or telemetry.

25. The geophysical measurement system of claim 23, wherein the programmed survey plan is modifiable based on electrical resistivity imaging data collected by the geophysical measurement system.
